(19) United States
(12) Patent Application Publication
(10) Pub. No.: US 2013/0196837 A1
(43) Pub. Date: Aug. 1, 2013

(54) CARDBOARD ARTICLE PRODUCTION LINE

(71) Applicants: Bernhard Kesseler, Neuwied (DE); Ade Pollard, Fareham (GB)

(72) Inventors: Bernhard Kesseler, Neuwied (DE); Ade Pollard, Fareham (GB)

(73) Assignee: HUHTAMAKI OYJ, Espoo (FI)

(21) Appl. No.: 13/878,913

(22) PCT Filed: Sep. 30, 2011
(86) PCT No.: PCT/EP2011/004903

§ 371 Date: Apr. 11, 2013

(30) Foreign Application Priority Data
Oct. 12, 2010 (EP) 10013527.6

(51) Int. Cl. B31B 1/14; B31B 1/88

(52) U.S. Cl. CPC B31B 1/14; B31B 1/88
USPC 493/55; 493/56; 493/84

(57) ABSTRACT

The present invention relates to a cardboard article production line. By means of this production line, cups with a single- or a double-sidewall can be produced. Trays, plates, boxes, particularly folded boxes, or the like can also be produced with the inventive production line.

The present invention relates to a cardboard article production line.

Cardboard article production lines are well known from the state in the art. In such cardboard article production lines, plane, semi-finished cardboard parts are cut out of a web and subsequently for example formed into the sidewall of the cardboard cup, whereby the ends of the cardboard part are attached, preferably glued together. In the past, such a cardboard article production line only comprised an article former machine. The semi finished parts were supplied in stacks, for example by a fork-lift-truck and then manually loaded into the article former. The semi-finished parts have been produced in another line, preferably centrally for a large number of article formers. However, this process is disadvantageous, because the material of the semi finished parts has to be transported several times, first as a reel and then as the semi-finished products.

It was therefore the objective of the present invention to provide a cardboard article production line, which does not comprise the deficiencies of the state of the art.

This objective is attained by a cardboard article production line whereby it comprises inline a cutting machine, which cuts semi finished parts out of a cardboard web and an article former, which forms each semi finished part, for example into the sidewall of an article.

The inventive cardboard article production line has the advantage that it is much more hygienic, because the semi finished parts are not stored in an intermediate storage unit where they can be contaminated with dust or the like. The production process is safer for the operator, because only a reel has to be transported to the production line. The process is also safer, because of less transport within the shop floor. The rest is automated. The inventive line is more energy efficient, because the semi finished parts need not be transported to a storage unit and it is faster than production lines according to the state of the art, because there is less downtime of the machines.

Cardboard according to the present invention also covers article made from paper. The cardboard and/or the paper can be multilayered and can be covered with a coating to make them more fluid-, fat, oxygen- and/or moisture-resistant. The cardboard- or paper material may comprise a sealing layer.

The present invention relates to a cardboard article production line. This production line comprises inline a cutting machine, which cuts semi-finished parts out of a cardboard web, which is preferably supplied to the production line as a reel, and an article former which forms each semi-finished part, for example into the sidewall of the article. Simultaneously or afterwards, preferably a bottom is attached to the sidewall. Particularly, the inventive production line refers a cup production line. These cups may comprise a single or a double-sidewall. Trays, plates, boxes, particularly folded boxes, or the like can also be produced with the inventive production line.

Inline, according to the present invention, means that each article former is associated one by one with a cutting machine, whereas one cutting machine is located upstream of one or more article formers. Inline, according to the present invention, further or alternatively means that the semi-finished parts are produced by the cutting machine in a capacity essentially as needed and are not stored as intermediate products in a storage facility. The semi-finished parts produced by the cutting machine are directly supplied to an article former, which is located downstream of the cutting machine and are there, for example, formed into the sidewall of the article. There can be more than one forming machine per each cutting machine.

The cutting machine is preferably a punch, which blanks the semi-finished products out of the cardboard web. Preferably, the semi-finished parts are cut out of the web such, whereas one semi-finished part is preferably turned by 90° or 180° relative to the next. This results in very little waste. The cutting machine preferably comprises an access to manually unload semi-finished parts. Preferably, the cutting tool(s) for the cutting machine is/are exchangeable, in order to be able to produce different articles on the inventive production line. Preferably, each tool comprises an identification, for example a transponder, so that the inventive production line knows which tool is presently in which machine. In case that the respective tool does not match with tools of the other components of the production line, an alarm will be triggered and/or the production line will not start its operation. The cutting machine, preferably the punch, operates preferably at up to 180 strokes per minute with more preferably up to 5 images, from which semi finished products are produced, across the width of the web. The web has preferably a width of up to 1000 mm. Minimum is 1 image across the width of the web. The width is preferably perpendicular to the transport direction of the web.

Preferably, the cutting machine comprises in the vicinity of its exit a separator, preferably one separator per row and/or per stack, whereas preferably the number of rows/stacks is identical to the number of images across the width of the web. The separator will divide each stack of semi finished products into a multitude of separated sections, each sector having a certain height and/or a certain number of semi finished products per section. This is achieved by, for example, inserting separation means into each stack, more preferably at regular intervals. The separation means can be for example one or more finger(s). The handover unit will then grip such a section, preferably separately per row. Additionally or alternatively, the individual stacks of semi finished products can be separated by separation means.

The article former forms a three dimensional product, for example, the sidewall of a cup, for example a cylindrical- or conical-sidewall, out of the plane semi-finished part. Therefore, the article former comprises, for example, a mandrel around which the semi-finished cardboard product is rolled. Preferably, the article former can operate independently from a handover-unit and/or the cutting machine. Preferably, the article former has an access for manual infeed of semi finished parts to the article former. Preferably, the forming tool(s) for the cutting machine is/are exchangeable, in order to be able to produce different articles on the inventive production line. Preferably, each tool comprises an identification, for example a transponder, so that the inventive production line knows which tool is presently in which machine of the production line. In case that the respective tool does not match with tools of the other components of the production line, an alarm will be triggered and/or the production line will not start its operation. The article former preferably operates at a production rate of up to 350 articles per minute.

Preferably a handover unit is placed between the cutting machine and one or more article former(s). This handover unit hands the semi-finished parts over to one or more article former(s). The semi-finished parts can be handed over piece by piece or batch-wise, i.e. several parts simultaneously. Preferably, the handover unit comprises a gripper, which grips the semi-finished products piece by piece or stackwise and hands them over to the article former. Preferably this gripper comprises vacuum means to attach the semi-finished part(s) to the gripper. Preferably, the gripper is exchangeable, in order to be able to produce different articles on the inventive production line. Preferably, each gripper comprises an identification, for example a transponder, so that the inventive production line knows which gripper is presently in which machine. In case that the respective gripper does not match with tools of the other components of the production line, an alarm will be triggered and/or the production line will not start its operation. Preferably, the handover unit controls the operation, for example number of semi-finished products produced per time unit, of the cutting machine. The operation, for example number of semi-finished products produced per time unit, of the handover unit is preferably controlled by the demand of the forming machine.

Each tool and/or gripper is preferably attached to the respective machine by means of a quick tool change. Such quick tool change means is for example a snap-, bayonet-connection of the like.

The hand over unit is, for example, a pick and place robot. Preferably, there is communication provided between the handover unit and the cutting machine and/or the article former, for example to slow down the cutting machine, when the article former is down and/or operates at a reduced production rate.

Preferably the cutting machine itself, the handover unit and/or the article former comprise means to turn, preferably every other, semi-finished part or a stack of semi finished parts by preferably 90° or 180°, so that all semi-finished parts, when processed in the article former, have the same orientation.

If needed, the semi-finished parts can be transferred from a vertical into a horizontal position or vice versa.

Preferably, the semi-finished parts are handed over piece by piece or batch-wise; i.e. several semi-finished parts simultaneously. These batches can be accumulated in the cutting machine and/or in the handover unit.

Preferably, the article former comprises transportation means onto which the semi-finished parts are handed over by the handover unit. This transportation means transports the semi-finished parts into the article former where they are formed, for example rolled around a mandrel to form the sidewall of a cup. Preferably, this transportation means is designed such, that it can also be loaded manually, for example by an operator, in case that the cutting machine and/or the hand over unit fails.

In a preferred embodiment of the present invention, the production line comprises inline a printer which is located upstream of one or more cutting machine(s). This printer prints images, same or different designs preferably simultaneously, on the cardboard web, before the semi-finished parts are blanked out of the web. In case different designs are printed, these designs are, after their separation handed to different article forming machines, respectively. This is preferably executed by the hand-over unit.

Preferably, the capacity of the cardboard production line is such, that the capacity of the cutting machine and/or the handover unit is higher than the capacity of the article former(s) located downstream from one or more cutting units.

Preferably, the article former comprises a buffer for the semi-finished parts. Preferably, the buffer capacity allows at least 20 minutes of production without delivery of semi-finished part from the cutting machine.

In a preferred embodiment, the cardboard article production line comprises a control unit, which controls commonly the cutting machine and the article former and preferably also the handover unit. Preferably, the control unit is designed such that the article former capacity is controllable. Preferably, the cardboard article production line is controlled such, that the production of the article former is continuous; i.e. that the article former keeps producing articles even in case that the production rate of the cutting machine and/or the handover unit is reduced, for example in case a new reel is supplied to the cutting machine or printing machine. In such a case, the capacity of the article former can be reduced. Regarding the control process, the article former preferably has the lead, i.e. the article former has to operate with the desired capacity. In case the production capacity of the article former is increased, the capacity of the other inline components have to be increased as well and vice versa. This preferred embodiment of the present invention has also the advantage that less waste is produced, because after each start-up of the article former the first articles have to be rejected.

In order to run the article former at its desired production rate, the production line preferably comprises a buffer for semi finished parts. This buffer is preferably located downstream from the cutting machine and more preferably has a capacity to operate the article former at least for 20 minutes at its desired production rate without any delivery of semi finished parts from the cutting machine. The inventive production line is preferably operated such, that this buffer is always filled to its maximum buffering capacity. More preferably, the buffer is regularly at least partially emptied and refilled in order to avoid that the buffered semi finished parts get contaminated.

Preferably, the inventive production line comprises means to automatically reject defective semi finished products from the production line. The production line therefore preferably comprises detection means, for example a camera, to analyze the shape of the semi finished parts. In case this shape is not as desired, the respective semi finished part is removed, for example by the handover unit. Preferably, the semi finished parts are recycled, in case the assessment of the detection means was wrong.

The inventive production line preferably allows the production of articles with a filling volume from 4 oz. up to 44 oz.

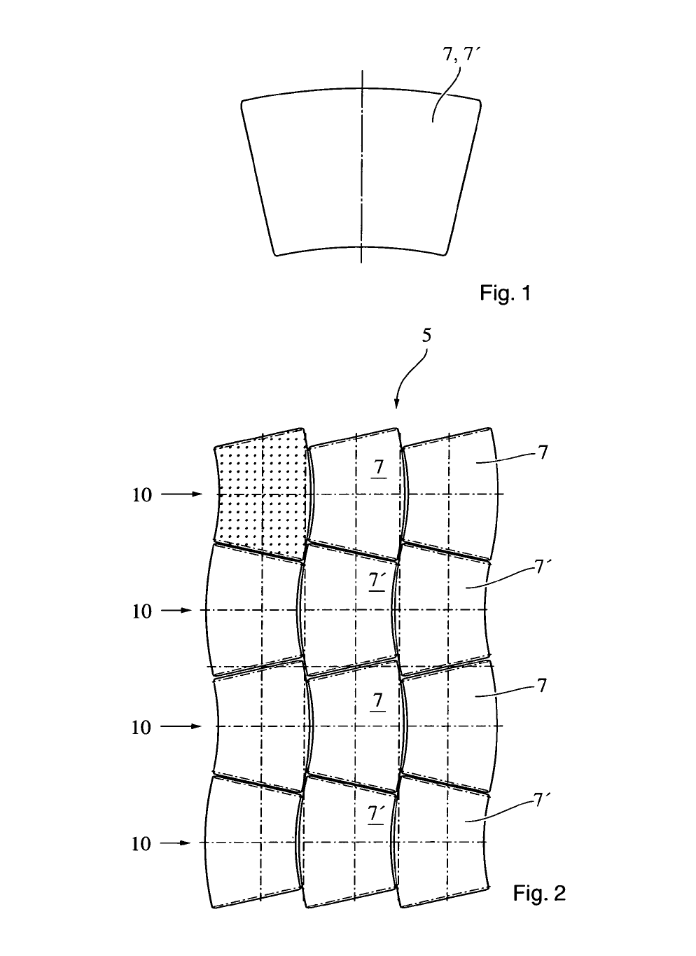

The invention is now explained in further detail according to FIGS. 1-5. These explanations do not limit the scope of protection.

FIG. 1 shows the semi-finished part.

FIG. 2 shows the web out of which the semi-finished parts are punched.

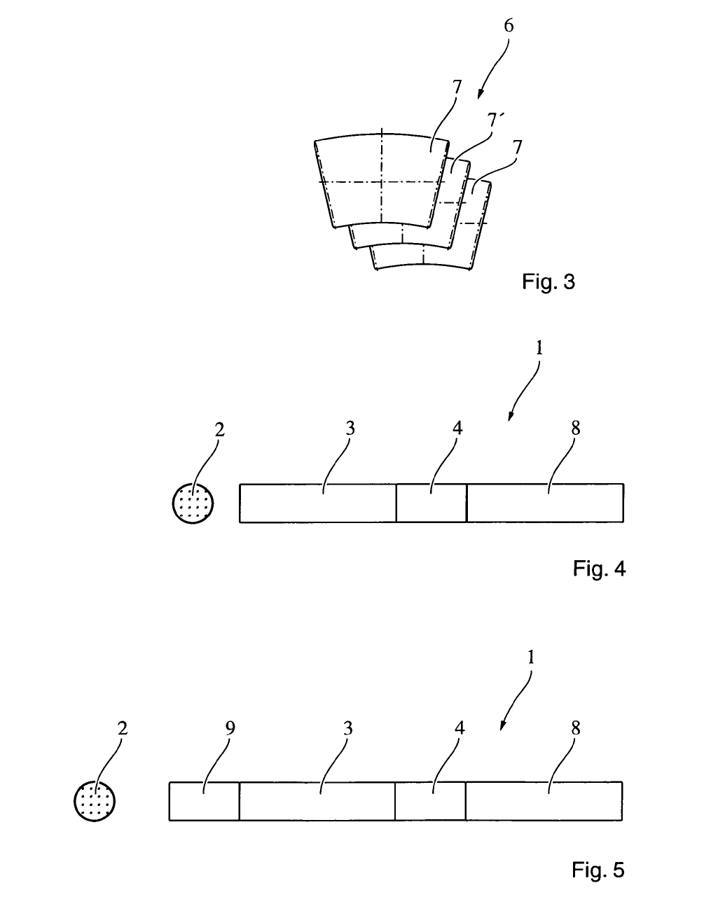

FIG. 3 shows the orientation of the parts prior to forming.

FIG. 4 shows a first embodiment of the inventive cardboard article production line.

FIG. 5 shows a second embodiment of the cardboard article production line.

FIG. 1 shows an example of a semi-finished part 7, 7′, which is formed into the sidewall of an article, here a cup. In the present case, the shape of the semi-finished part results in a conical sidewall of the cup.

FIG. 2 shows the cardboard web 5 out of which the semi-finished parts 7, 7′ are cut, for example punched. In the present case, the width of the web 5 is such that three rows 10 of semi-finished parts 7, 7′ can be placed next to each other. In order to save material, the semi-finished parts 7, 7′ are oriented such that each part 7′ is turned by 180° relative to each adjacent part 7. This assures that least waste is produced. According to the present invention, either the parts 7 or the parts 7′ are turned by 180°, after they have been singularized. This assures that all parts 7, 7′ have the same orientation in the article former. This orientation is depicted in FIG. 3, which shows a stack of semi-finished parts 7, 7′. It can be seen that in the present case all parts 7, 7′ have the same orientation. The turning of the semi-finished parts 7, 7′ can be executed in the cutting machine, by the handover unit or in the article former. However, it is preferred that this task is taken over by the handover unit or by the cutting machine.

FIG. 4 shows a first embodiment of the inline cardboard article production line 1. This line 1 comprises a cutting machine 3, a handover unit 4 and an article former 8. A reel 2 which comprises the furled cardboard web is transported to line 1. Out of the web, which is transported along the cutting machine 3, semi-finished 7, 7′ are cut out, as depicted in FIG. 2. These parts are then handed over to the article former by a handover unit 4, for example a robot, which hands the stacks batch-wise, i.e. a multitude of parts 7, 7′ simultaneously or piece by piece over to the article former. Prior to the handover or during the handover, every other semi-finished 7, 7′ is turned by preferably 180° so that they all have the same orientation, when formed in the article former. The article former preferably comprises a transportation means, for example a transportation belt or a magazine, onto which the semi-finished parts are loaded and then transported into the article former. This transportation means can be also accessed by an operator so that in case that either the cutting machine 3 or the handover unit 4 fails, the article former 8 can be kept in production. Preferably, the article former 8 comprises a buffer for semi-finished products so that the article former can keep producing articles even in case that the cutting machine or the handover unit is down. Preferably, the inventive line 1 comprises a control unit, which controls the cutting machine 3, the handover unit 4 and the article former 8. Preferably, the process is controlled such that the article former 8 is always kept under production. In case that a reel 2 needs to be exchanged, the control unit will reduce the production capacity of the article former 8. Preferably, the capacity of the cutting machine 4 and the hand over unit are larger than the capacity of the article-former 8.

FIG. 5 shows essentially the production line according to FIG. 4. However, in the present case, upstream of the cutting machine 3 a printer 9 is arranged. This printer prints inline images on the cardboard web prior to the individualization of the semi-finished products. The printer 9 is preferably also controlled by a control unit.

### LIST OF REFERENCE SIGNS

1 Cardboard article production line
2 Reel feed
3 Cutting machine, punch
4 Handover unit
5 Cardboard web
6 Stack of parts 7, 7′
7, 7′ Semi finished part
8 article former
9 printer
10 row

1. Cardboard article production line comprising inline:
a cutting machine, which cuts semi-finished parts out of a cardboard web; and
an article former, which forms each semi-finished part.

2. Cardboard article production line according to claim 1, wherein a handover unit is placed between the cutting machine and the article former, which hands the semi-finished parts over to the article former.

3. Cardboard article production line according to claim 2, wherein the semi-finished are handed over piece by piece, or batch-wise.

4. Cardboard article production line according to claim 1 further comprising a turning unit, which turns every other semi-finished part, preferably by 90° or 180°.

5. Cardboard article production line according to claim 2, wherein the article former comprises transportation means onto which the semi-finished parts are handed over by the handover unit.

6. Cardboard article production line according to claim 5, wherein the transportation means can be loaded manually.

7. Cardboard article production line according to claim 1 further comprising inline a printer upstream of the cutting machine.

8. Cardboard article production line according to claim 2, wherein a capacity of the cutting machine and/or the handover unit is higher than a capacity of the article former.

9. Cardboard article production line according to claim 1, wherein the article former comprises a buffer for the semi-finished parts.

10. Cardboard article production line according to claim 1, wherein a capacity of the article former is controllable.
